(19) United States
(12) Patent Application Publication
(10) Pub. No.: US 2018/0188597 A1
(43) Pub. Date: Jul. 5, 2018

(54) COLOR FILTER SUBSTRATE, METHOD FOR MANUFACTURING THE SAME AND DISPLAY DEVICE

(71) Applicants: BOE TECHNOLOGY GROUP CO., LTD., Beijing (CN); HEFEI XINSHENG OPTOELECTRONICS TECHNOLOGY CO., LTD., Hefei (CN)

(72) Inventors: Songyang JIANG, Beijing (CN); Liangliang JIANG, Beijing (CN); Ke DAI, Beijing (CN); Yongjun YOON, Beijing (CN)

(73) Assignees: BOE TECHNOLOGY GROUP CO., LTD., Beijing (CN); HEFEI XINSHENG OPTOELECTRONICS TECHNOLOGY CO., LTD., Hefei (CN)

(21) Appl. No.: 15/683,426

(22) Filed: Aug. 22, 2017

(30) Foreign Application Priority Data
Jan. 3, 2017 (CN) 201710002473.9

(51) Int. Cl. G02F 1/1335

(52) U.S. Cl. CPC G02F 1/133516; G02F 2201/503; G02F 1/133514

(57) ABSTRACT

At least one embodiment of the present disclosure provides a color filter substrate, a method for manufacturing the same and a display device. The method includes: forming a first color filter layer, a second color filter layer and a third color filter layer respectively located at the first subpixel region, the second subpixel region and the third subpixel region on a base substrate; wherein the first color filter layer, the second color filter layer and the third color filter layer have a first thickness; forming a protection layer covering the base substrate; and forming a spacer and a spacer material reservation portion above the protection layer, wherein the spacer material reservation portion is located at the fourth subpixel region, and the spacer material reservation portion has a thickness which is substantially equal to the first thickness.

### CROSS-REFERENCE TO RELATED APPLICATION

This application claims priority to Chinese Patent Application No. 201710002473.9 filed on Jan. 3, 2017, which is incorporated herein by reference in its entirety.

### TECHNICAL FIELD

The present disclosure relates to a field of display technologies, in particular to a color filter substrate, a method for manufacturing the same and a display device.

### BACKGROUND

A four-color (RGBW, i.e., Red; Green; Blue; White) liquid crystal display device is formed by adding a W pixel made of a transparent material on a three-color (RGB) liquid crystal display device, to increase a transmittance of a liquid crystal display panel. Since the four-color (RGBW) liquid crystal display device has a relatively high light transmittance and a relatively high luminance, a demand for a backlight luminance may decrease, and the cost of the liquid crystal display device can be further lowered, thereby increasing the market demand.

The four-color (RGBW) liquid crystal display device may include two substrates which are arranged opposite and in alignment with each other. An upper substrate of the two substrates may be, for example, a color filter substrate, and a lower substrate of the two substrates may be, for example, an array substrate. A plurality of RGBW color filter layers arranged regularly is formed in the color filter substrate. Currently, a process for manufacturing a four-color (RGBW) color filter substrate mainly includes a PW process (in which a W color filter layer is made of a post spacer (PS) material) and a CW process (in which a W color filter layer is made of an over coat (PS) material). In the PW process, after a black matrix (BM) and RGB color filter layers are formed, it needs to separately coating a layer of the PS material, and to form the W color filter layer through an additional patterning process, thereby prolonging time required to manufacture the color filter substrate, which is disadvantageous for mass production. In the CW process, subsequent to the formation of the BM and the RGB color filter layers, the color filter substrate is coated with an OC layer directly, and in a region corresponding to the W color filter layer, there is no color filter layer material under the OC layer. Therefore, a height of a film layer at the W color filter layer is apparently lower than that of the film layer at the RGB color filter layers, which leads to a poor flatness the entirety of the color filter substrate.

### SUMMARY

At least one embodiment of the present disclosure provides a color filter substrate, a method for manufacturing the same, and a display device.

In a first aspect, the at least one embodiment of the present disclosure provides a method for manufacturing a color filter substrate, the color filter substrate being divided into a first subpixel region, a second subpixel region, a third subpixel region and a fourth subpixel region; the method including: forming a first color filter layer, a second color filter layer and a third color filter layer respectively located at the first subpixel region, the second subpixel region and the third subpixel region on a base substrate; wherein the first color filter layer, the second color filter layer and the third color filter layer have a first thickness; forming a protection layer covering the base substrate; and; forming a spacer and a spacer material reservation portion above the protection layer, wherein the spacer material reservation portion is located at the fourth subpixel region, and the spacer material reservation portion has a thickness which is substantially equal to the first thickness.

Optionally, the forming a spacer and a spacer material reservation portion above the protection layer includes: forming a transparent insulating layer covering the protection layer; wherein the transparent insulating layer has a thickness which is larger than the first thickness; and forming the spacer and the spacer material reservation portion on the protection layer by performing a single patterning process on the transparent insulating layer.

Optionally, the transparent insulating layer is made of a photoresist material.

Optionally, the forming the spacer and the spacer material reservation portion on the protection layer by performing a single patterning process on the transparent insulating layer includes: exposing and developing the transparent insulating layer with a mask plate, so as to form a completely-reserved portion, a partially-reserved portion and an completely-removed region; wherein the completely-reserved portion forms the spacer; the partially-reserved portion forms the spacer material reservation portion, and the partially-reserved portion has a thickness which is substantially equal to the first thickness; the completely-removed region corresponds to a region other than regions where the completely-reserved portion and the partially-reserved portion are located on the transparent insulating layer.

Optionally, the mask plate is a gray-tone mask plate or a half-tone mask plate.

Optionally, before exposing and developing the transparent insulating layer with the mask plate, the method further includes determining a light shielding rate of a partially transparent region corresponding to the spacer material reservation portion in the mask plate according to the thickness of the spacer material reservation portion and the thickness of the transparent insulating layer.

Optionally, the transparent insulating layer is made of a positive photoresist; and the light shielding rate of the partially transparent region is a ratio of the thickness of the spacer material reservation portion to the thickness of the transparent insulating layer.

Optionally, the transparent insulating layer is made of a negative photoresist; and the light shielding rate of the partially transparent region is a ratio of a difference between the thickness of the transparent insulating layer and the thickness of the spacer material reservation portion to the thickness of the transparent insulating layer.

Optionally, before forming the completely-reserved portion, the partially-reserved portion and the completely-removed region, the method further includes determining an exposure intensity and an exposure time according to the thickness of the partially-reserved portion.

Optionally, before forming the first color filter layer, the second color filter layer and the third color filter layer respectively located at the first subpixel region, the second subpixel region and the third subpixel region on the base substrate, further includes forming a black matrix on the base substrate, wherein an open region of the black matrix defines the first subpixel region, the second subpixel region, the third subpixel region and the fourth subpixel region.

Optionally, the spacer is located at the first subpixel region, the second subpixel region and the third subpixel region.

Optionally, the first color filter layer is a red color filter layer, the second color filter layer is a green color filter layer and the third color filter layer is a blue color filter layer.

Optionally, before forming the first color filter layer, the second color filter layer and the third color filter layer respectively located at the first subpixel region, the second subpixel region and the third subpixel region on the base substrate, further includes forming a transparent electrostatic shielding layer at one side of the base substrate away from the protection layer.

In a second aspect, the at least one embodiment of the present disclosure further provides a color filter substrate, being divided into a first subpixel region, a second subpixel region, a third subpixel region and a fourth subpixel region, including: a first color filter layer, a second color filter layer and a third color filter layer respectively located at the first subpixel region, the second subpixel region and the third subpixel region on a base substrate; a protection layer covering the base substrate; and a spacer and a spacer material reservation portion arranged above the protection layer; wherein the first color filter layer, the second color filter layer and the third color filter layer have a first thickness; and the spacer material reservation portion is located at the fourth subpixel region, and the spacer material reservation portion has a thickness which is substantially equal to the first thickness.

Optionally, the spacer and the spacer material reservation portion are made of a transparent insulating material.

Optionally, the transparent insulating material comprises a photoresist material.

Optionally, the spacer is located at the first subpixel region, the second subpixel region and the third subpixel region.

Optionally, the color filter substrate further includes a black matrix arranged on the base substrate, wherein an open region of the black matrix defines the first subpixel region, the second subpixel region, the third subpixel region and the fourth subpixel region.

Optionally, a transparent electrostatic shielding layer arranged at one side of the base substrate away from the protection layer.

In a third aspect, the at least one embodiment of the present disclosure further provides a display device, including any one of the above-mentioned color filter substrates.

### BRIEF DESCRIPTION OF THE DRAWINGS

In order to more clearly explain the technical solutions of the embodiments of the present disclosure or a related art, the drawings to be used in the descriptions of the embodiments or the related art are briefly introduced as follows. Apparently, the following drawings merely illustrate some embodiments of the present disclosure, and a person skilled in the art can obtain other drawings from these drawings without any creative effort.

FIG. 1 is a structural schematic diagram of a color filter substrate manufactured by the PW process according to the related art;

FIG. 2 is a structural schematic diagram of a color filter substrate manufactured by the CW process according to the related art;

FIG. 3 is an operation schematic diagram of performing a rubbing alignment process on the color filter substrate shown in FIG. 2;

FIG. 4 is a flow chart of a method for manufacturing a color filter substrate according to some embodiments of the present disclosure;

FIG. 5 is a schematic diagram showing a specific structure in step S01 of FIG. 4;

FIG. 6 is a schematic diagram showing a specific structure in step S02 of FIG. 4;

FIG. 7 is a schematic diagram showing a specific structure in step S03 of FIG. 4;

FIG. 8 is a schematic diagram showing a specific structure in step S04 of FIG. 4;

FIG. 9 is a schematic diagram of an exposure mode in step S04; and

FIG. 10 is a schematic diagram showing a specific structure of a transparent electrostatic shielding layer formed prior to the step S01 of a method for manufacturing a color filter substrate according to some embodiments of the present disclosure.

### REFERENCE NUMERALS

01—color filter substrate; 10—base substrate; 20—black matrix; 31—first color filter layer; 32—second color filter layer; 33—third color filter layer; 34—fourth color filter layer; 40—protection layer; 50—transparent insulating layer; 501—completely-reserved portion; 502—partially-reserved portion; 503—completely-removed region; 51—spacer; 52—spacer material reservation portion; 60—transparent electrostatic shielding layer; 02—gray-tone mask plate or half-tone mask plate.

### DETAILED DESCRIPTION

The technical solutions in the embodiments of the present disclosure will be clearly and completely described hereinafter in combination with the accompanying drawings. Apparently, these embodiments described herein are merely parts of the embodiments of the present disclosure rather than all the embodiments. Based on the embodiments of the present disclosure, any other embodiments obtained by a person skilled in the art without any creative effort shall fall within the protection scope of the present disclosure.

It shall be pointed out that unless otherwise defined, all terms (including technical and scientific terms) used herein have the same meaning as commonly understood by one of ordinary skill in the art to which the present disclosure belongs. It should be understood that terms, such as those defined in commonly used dictionaries, should be interpreted as having meanings that is consistent with their meaning in the context of the relevant art and will not be interpreted in an idealized or overly formal sense, unless explicitly defined as such herein.

For example, the word “comprise” or “include” or the like used in the specification and claims of the present disclosure means that an element or a component which appears before a word contains elements or components listed after the word and equivalents thereof, not excluding other elements or components. The terms indicating an orientation or position relationship such as “upper (above)”, “lower (below)” are those based on Figures, merely to simply describe the technical solution of the present disclosure, instead of indicating or implying that the specified device or element have a specific orientation and be constructed and operated in the specific orientation, and therefore should not be constructed as a limit to the present disclosure.

Furthermore, due to a tiny actual size of each subpixel region in the color filter substrate according to the embodiments of the present disclosure, for the sake of clarity, unless otherwise defined, the size of each structure in the drawings of the embodiment of the present disclosure is in an enlarged scale, instead of representing the actual size or ratio.

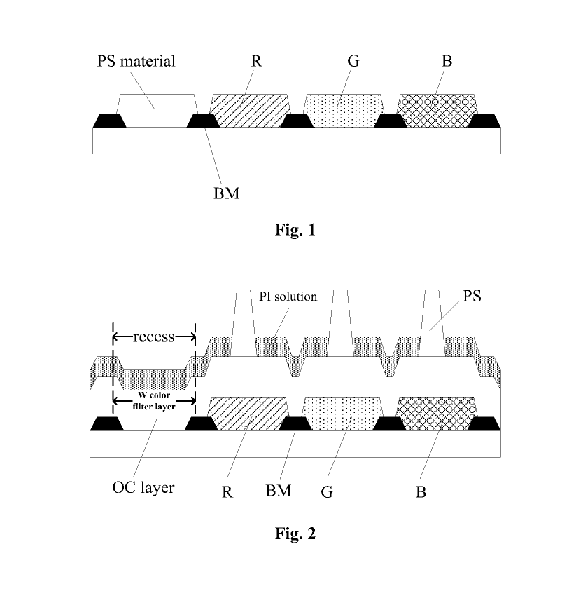

FIG. 1 schematically shows a structural diagram of a color filter substrate manufactured by the PW process. As shown in FIG. 1, in the PW process, after forming a black matrix (BM) and RGB color filter layers, a layer of PS material is separately applied, and a W color filter layer is formed by the patterning process. The PS material has the same thickness as the RGB color filter layers, such that a height of the formed W color filter layer is equal to that of the RGB color filter layers. In this way, the color filter substrate has a better flatness, but in this process, an additional patterning process is desirable, which prolongs the time required to manufacture the color filter substrate. As a result, it is disadvantageous for mass production.

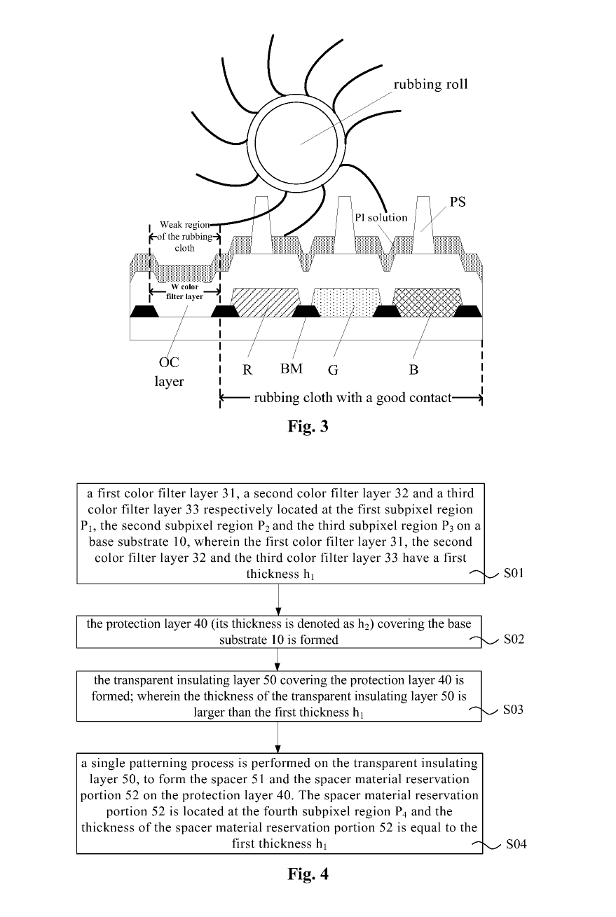

FIG. 2 schematically shows a structural diagram of a color filter substrate manufactured by the CW process. As shown in FIG. 2, in the CW process, an OC layer is coated on the color filter substrate directly subsequent to the formation of the BM and the RGB color filter layers, without a patterning process of exposing or developing. In this way, the time required to manufacture the color filter substrate is equivalent to the time required to manufacture the three-color (RGB) color filter substrate in the related art, which is beneficial to the mass production. However, since the OC layer is covered onto the BM and the RGB color filter layers directly, at a region corresponding to a W color filter layer, there is no color filter layer material under the OC layer, i.e., a recess region. Therefore, a total height of a film layer at the W color filter layer manufactured by the CW process is apparently lower than that of a film layer at the RGB color filter layers, which leads to a poor flatness of the entirety of the color filter substrate. Specifically, as shown in FIG. 3, in the case of performing a rubbing alignment process on a PI solution (an alignment layer solution, simply referred to as PI since it is usually made of a polyimide material) coated on a surface of the color filter substrate by means of a rubbing roll, a weak alignment region tends to occur, or particles and contaminants tend to be introduced, which adversely influences quality of a screen display. Meanwhile, due to the poor flatness of the entirety of the color filter substrate manufactured by the CW process, a cell thickness measuring accuracy of a liquid crystal panel formed by aligning the color filter substrate and the array substrate, and a calculated result of the height of a spacer (eg, simply referred to as PS in the drawing) arranged between the two substrates are adversely affected.

It should be understood that the structure of the color filter substrate shown in FIGS. 1-3 is merely for convenient understanding of the problems existing in the related art, and not to limit the present disclosure.

As shown in FIG. 4, at least one embodiment of the present disclosure provides a method for manufacturing a color filter substrate, the color filter substrate 01 being divided into a first subpixel region, a second subpixel region, a third subpixel region and a fourth subpixel region. This manufacturing method includes the following steps.

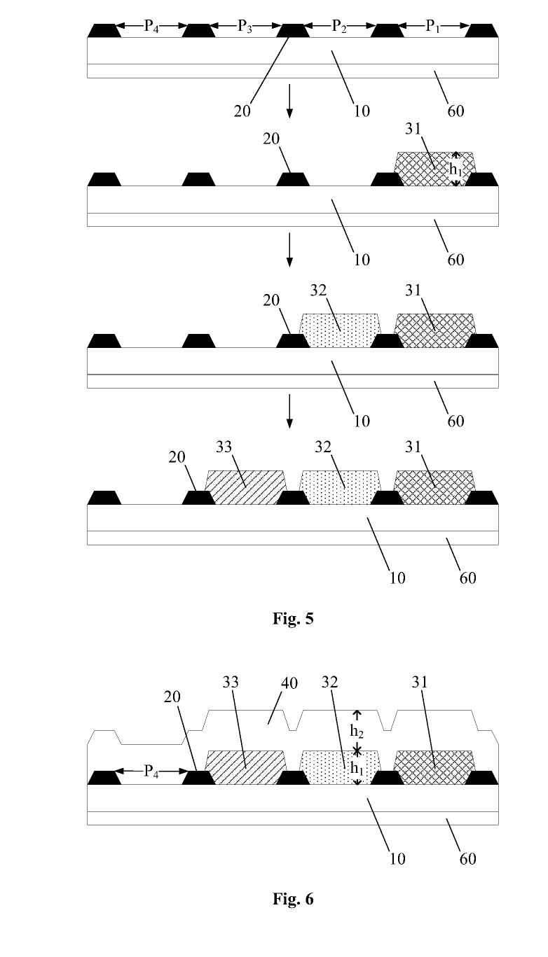

In step S01, as shown in FIG. 5, a first color filter layer 31, a second color filter layer 32 and a third color filter layer 33, respectively located at the first subpixel region (denoted as P₁ in the drawings), the second subpixel region (denoted as P₂ in the drawings) and the third subpixel region (denoted as P₃ in the drawings), are formed on a base substrate 10, wherein the first color filter layer 31, the second color filter layer 32 and the third color filter layer 33 have a first thickness (denoted as h₁ in the drawings hereinafter).

In the step S02, as shown in FIG. 6, the protection layer 40 (its thickness is denoted as h₂ in the drawing hereinafter) covering the base substrate 10 is formed.

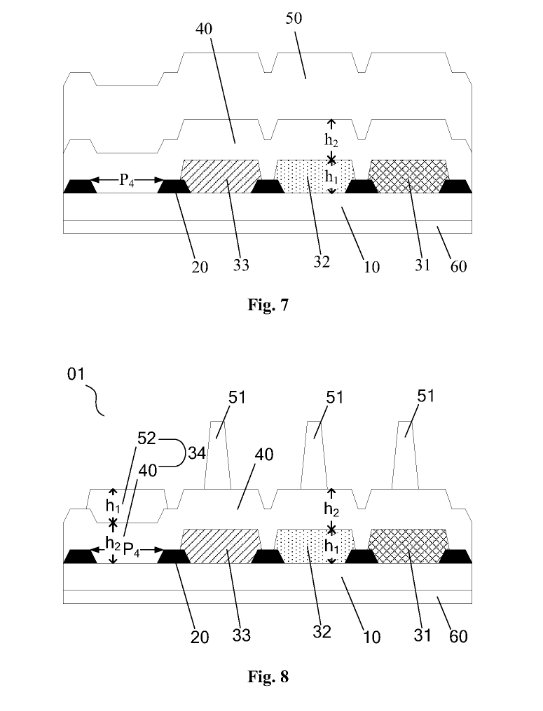

In the step S03, as shown in FIG. 7, the transparent insulating layer 50 covering the protection layer 40 is formed; wherein the thickness of the transparent insulating layer 50 is larger than the first thickness h₁.

In the step S04, as shown in FIG. 8, a single patterning process is performed on the transparent insulating layer 50, to form the spacer 51 and the spacer material reservation portion 52 on the protection layer 40. The spacer material reservation portion 52 is located at the fourth subpixel region P₄ and the thickness of the spacer material reservation portion 52 is equal to the first thickness h₁.

It should be noted that prior to the step S01, the above manufacturing method further includes the step of forming a black matrix 20 on the base substrate 10, wherein an open region of the black matrix 20 defines the above-mentioned first subpixel region P₁, the second subpixel region P₂, the third subpixel region P₃ and the fourth subpixel region P₄.

In the above-mentioned step S01, the formed first color filter layer 31 may be specifically a red color filter layer (simply referred to as an R color filter layer hereinafter); the second color filter layer 32 may be specifically a green color filter layer (simply referred to as a G color filter layer hereinafter); and the third color filter layer 33 may be specifically a blue color filter layer (simply referred to as a B color filter layer hereinafter). The specific process for successively forming the red color filter layer, green color filter layer and blue color filter layer may refer to the related art, and is not limited in the embodiments of the present disclosure.

FIG. 5 merely schematically shows an arrangement of the first subpixel region P₁, a second subpixel region P₂, a third subpixel region P₃ and a fourth subpixel region P₄, which is not limited by the embodiments of the present disclosure. The arrangement of the four-color (RGBW) subpixel may refer to such arrangements in the related art as a strip shape, a mosaic shape, a Delta shape, or the like.

It should be understood by a person skilled in the art that the protection layer 40 covering the first color filter layer 31, the second color filter layer 32 and the third color filter layer 33 and corresponding to the fourth subpixel region P₄ has a uniform thickness. That is, the thickness of the protection layer 40 covering the R, G, B color filter layers is the same as that of the protection layer 40 covering the fourth subpixel region P₄, that is the fourth subpixel region P₄ to be formed on the base substrate 10 exposed by the black matrix 20.

In the above-mentioned step S04, a patterning processing refers to a processing performed on a film layer, so as to obtain a corresponding pattern, and may include applying a single mask plate, and exposing and developing by the photoresist.

The spacer material reservation portion 52 with a certain pattern and thickness is formed together with the spacer 51 in the same single patterning process. Therefore the number of patterning processes may not be increased as compared with that in manufacturing the color filter substrate by the CW process.

Subsequent to the patterning processing in the step S04, the spacer material reservation portion 52 is formed at the fourth subpixel region P₄, and has a thickness which is equal to the first thickness h₁ of R, G or B color filter layer. Therefore, the transparent spacer material reservation portion 52 and part of the protection layer 40 below the transparent spacer material reservation portion 52 covering the fourth subpixel region P₄ form the fourth color filter layer 34, i.e., the W color filter layer.

Since the protection layer 40 covering the first color filter layer 31, the second color filter layer 32 and the third color filter layer 33 and corresponding to the fourth subpixel region P₄ has a uniform thickness. The thickness of the spacer material reservation portion 52 is obtained by subtracting the thickness of the film layer of the protection layer 40 covering the fourth subpixel region P₄ from the total thickness of the film layer of the protection layer 40 covering the R, G or B color filter layers, that is the thickness of the spacer material reservation portion 52 is equal to the first thickness h₁ of the R, G or B color filter layer.

Thus, an actual thickness (denoted as h_{w} hereinafter) of the W color filter layer is h_{w}=h₁+h₂. The thickness of the film layer on the base substrate 10 corresponding to the R, G, or B color filter layer is also h₁+h₂, so that the manufactured color filter substrate has a uniform evaporation thickness.

Based on this, by means of the above-mentioned manufacturing method according to the at least one embodiment of the present disclosure, on the color filter substrate manufactured by the CW process, after coating a whole protection layer, the spacer material reservation portion with the same thickness as the first color filter layer, the second color filter layer and the third color filter layer is formed simultaneously with the spacer in a same single patterning process, without increasing the number of patterning processes of the color filter substrate. The spacer material reservation portion fills the recess of the protection layer corresponding to the fourth subpixel region, finally to obtain the fourth color filter layer (that is, the W color filter layer) formed by the protection layer and the spacer material reservation portion. Since the protection layer and the spacer material have excellent light transmission, the superimposition of the two insulating layers does not affect the transmission of a white light as a backlight source. In the above-mentioned manufacturing method according to the embodiment of the present disclosure, the film thickness of the color filter substrate corresponding to the W color filter layer is equal to that of the color filter substrate corresponding to the R, G and B color filter layers, and the obtained color filter substrate has a uniform film thickness, which facilitates the measurement of a liquid crystal cell thickness of the aligned color filter substrate, the calculation of the spacer height and the design and analysis of the liquid crystal panel in a later stage. Accordingly, the liquid crystal cell thickness can be measured more accurately, the weak alignment region is effectively avoided in the rubbing process after coating the PI solution on the color filter substrate, and the quality of the panel is improved.

In some embodiments, based on this, the transparent insulating layer in the above-mentioned step S03 is made of the photoresist material. As such, the corresponding spacer and the spacer material reserved layer can be formed only through exposure and development in the subsequent patterning processing in the step S04, without an additional etching-off process, which further simplifies the above-mentioned process for manufacturing the color filter substrate, shortens a product developing period and lowers the production cost.

Corresponding to the step S03 of forming the transparent insulating layer 50 made of the photoresist material, the step S04 specifically includes the following steps.

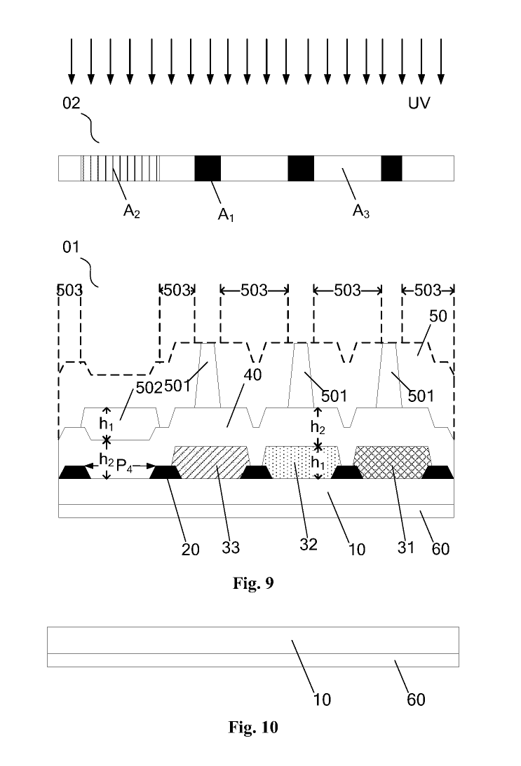

As shown in FIG. 9, the completely-reserved portion 501, the partially-reserved portion 502 and the completely-removed region 503 are formed by exposing and developing the transparent insulating layer 50 (shown by an dashed line in the drawings) by using the mask plate (such as the gray-tone mask plate or the half tone mask plate 02). The completely-reserved portion 501 forms the spacer; the partially-reserved portion 502 forms the spacer material reservation portion located at the fourth subpixel region P₄, and the thickness of the partially-reserved portion 502 is equal to the first thickness h₁; and the completely-removed region 503 corresponds to a region other than the region where the completely-reserved portion 501 and the partially-reserved portion 502 are located on the transparent insulating layer 50.

The exposure principle of the half-tone mask plate or the gray-tone mask plate may refer to the related art, and is not repeated in the embodiment of the present disclosure.

It should be noted that in FIG. 9, only the transparent insulating layer 50 made of the positive photoresist is taken as an example. That is, in the case that the transparent insulating layer 50 is made of the positive photoresist, the completely-reserved portion 501, the partially-reserved portion 502 and the completely-removed region 503 formed by UV exposing and developing correspond to an nontransparent (denoted as A₁ in the drawings), a partially transparent region (denoted as A₂ in the drawings) and a completely transparent region (denoted as A₃ in the drawings) of the above-mentioned gray-tone mask plate or the half-tone mask plate 02, respectively. In contrast, in the case that the transparent insulating layer 50 is made of the negative photoresist, the completely-reserved portion 501, the partially-reserved portion 502 and the completely-removed region 503 formed by UV (Ultraviolet) exposing and developing correspond to a completely transparent region, a partially transparent region and an nontransparent region of the above-mentioned gray-tone mask plate or the half-tone mask plate 02, respectively.

Furthermore, FIG. 9 only schematically shows one possible arrangement of the spacers 51 on the protection layer 40, which is not limited by the embodiment of the present disclosure. The arrangement of the spacers 51 can also refer to the related art. For example, the spacers 51 can be arranged above the black matrixes 20, and in one-to-one correspondence with the black matrixes 20.

The formation of the partially-reserved portion 502 with a thickness equal to the first thickness h₁ can specifically be controlled according to a light shielding rate of the gray-tone mask plate or the half-tone mask plate. Or, it may be controlled by the exposure intensity and the exposure time (a product of both of them is an exposure amount) of the gray-tone mask plate or the half-tone mask plate.

In some embodiments, the light shielding rate (that is, a degree of shielding the light in exposing, usually represented by a percentage) of the partially transparent region A₂ corresponding to the spacer material reservation portion 52 to be formed in the above-mentioned gray-tone mask plate or the half-tone mask plate 02 is selected according to a ratio of the first thickness h₁ of the spacer material reservation portion 52 to be formed to the thickness of the transparent insulating layer 50 (that is, the height of the spacer).

Specifically, in the case that the transparent insulating layer 50 is made of the positive photoresist, since the positive photoresist has a property of not dissolving in a developing liquid before UV exposure and dissolving after UV exposure, the light shielding rate of the partially transparent region A₂ of the gray-tone mask plate or the half-tone mask plate 02 has a following relationship with the formed spacer material reservation portion 52 with the first thickness h₁:

an UV light transmittance of A₂=1−the light shielding rate of A₂

=a dissolving amount of the positive photoresist of the region A₂/a total amount of the positive photoresist of the region A₂ before exposure

=(thickness of the transparent insulating layer−the first thickness)/the thickness of the transparent insulating layer.

That is, the light shielding rate of the partially transparent region A₂ is equal to the first thickness h₁ divided by the thickness of the transparent insulating layer.

In contrast, in the case that the transparent insulating layer 50 is made of the negative photoresist, since the negative photoresist has a property of dissolving in a developing liquid before UV exposure and not dissolving after UV exposure, the light shielding rate of the partially transparent region A₂ of the gray-tone mask plate or the half-tone mask plate 02 has a following relationship with the formed spacer material reservation portion 52 with the first thickness h₁:

an UV light transmittance of A₂=1−the light shielding rate of A₂

=a curing amount of the positive photoresist of the region A₂/a total amount of the positive photoresist of the region A₂ before exposure

=the first thickness/the thickness of the transparent insulating layer.

That is, the light shielding rate of the partially transparent region A₂ is equal to a difference between the thickness of the transparent insulating layer and the first thickness divided by the thickness of the transparent insulating layer.

Optionally, the exposure intensity and the exposure time are selected according to the thickness of the partially-reserved portion 502 to be formed, so as to form the partially-reserved portion 502 with a thickness equal to the first thickness.

In some embodiments, as shown in FIG. 10, prior to the above-mentioned step S01, the above-mentioned manufacturing method according to the embodiment of the present disclosure further includes the step of forming a transparent electrostatic shielding layer 60 at one side (that is, a back side) of the base substrate 10 away from the protection layer 40. This transparent electrostatic shielding layer 60 can reduce the influence of electrostatic charges accumulated on a screen surface on normal deflection of a liquid crystal in the case that the color filter substrate is applied to the liquid crystal display device.

In some embodiments, the transparent electrostatic shielding layer 60 may be made of a transparent conductive material such as Indium Tin Oxide (ITO), Indium Zinc Oxide (IZO), Fluorine-Doped Tin Oxide (FTO), or the like, and is formed by a film forming technology such as sputtering. The specific process also can follow the related art, and is not limited in the embodiment of the present disclosure.

Based on this, the at least one embodiments of the present disclosure further provides a color filter substrate 01 obtained by the above-mentioned manufacturing method. As shown in FIG. 8, the color filter substrate 01 is divided into a first subpixel region P₁, a second subpixel region P₂, a third subpixel region P₃ and a fourth subpixel region P₄. The color filter substrate 01 specifically includes a first color filter layer 31, a second color filter layer 32 and a third color filter layer 33 respectively located at the first subpixel region P₁, the second subpixel region P₂ and the third subpixel region P₃ on a base substrate 10, wherein the first color filter layer 31, the second color filter layer 32 and the third color filter layer 33 have a first thickness h₁; a protection layer 40 covering the base substrate 10; and a spacer 51 and a spacer material reservation portion 52 arranged above the protection layer 40. The spacer 51 and the spacer material reservation portion 52 are made of transparent insulating materials. The spacer material reservation portion 52 is located at the fourth subpixel region P₄ and the thickness of the spacer material reservation portion 52 is equal to the first thickness h₁.

That is, the transparent spacer material reservation portion 52 and part of the protection layer 40 covering the fourth subpixel region P₄ below the transparent spacer material reservation portion 52 form the fourth color filter layer 34 corresponding to the fourth subpixel region P₄.

Further, in order to simplify the manufacturing process of the spacer 51 and the spacer material reservation portion 52, the transparent insulating material made of the spacer 51 and the spacer material reservation portion 52 is the photoresist material.

Based on this, the at least one embodiment of the present disclosure further provides a display device, including the above-mentioned color filter substrate 01. Specifically, this display device may be a liquid crystal display device, or may be any product or part with a display function, such as a liquid crystal display, a liquid crystal TV, a digital photo frame, a mobile phone, a tablet PC, or the like.

The forgoing is merely specific embodiment of the present disclosure, but the protection scope of the present disclosure is not limited thereto. Various variations or substitutions within the technical scope disclosed in the present disclosure are conceivable to any person skilled in the art, and shall fall within the scope of the present disclosure. Therefore, the protection scope of the present disclosure shall be subject to the protection scope defined by the claims.

What is claimed is:

1. A method for manufacturing a color filter substrate, the color filter substrate being divided into a first subpixel region, a second subpixel region, a third subpixel region and a fourth subpixel region, the method comprising:
forming a first color filter layer, a second color filter layer and a third color filter layer respectively located at the first subpixel region, the second subpixel region and the third subpixel region on a base substrate; wherein the first color filter layer, the second color filter layer and the third color filter layer have a first thickness;
forming a protection layer covering the base substrate; and
forming a spacer and a spacer material reservation portion above the protection layer, wherein the spacer material reservation portion is located at the fourth subpixel region, and the spacer material reservation portion has a thickness which is substantially equal to the first thickness.

2. The method according to claim 1, wherein the forming a spacer and a spacer material reservation portion above the protection layer comprises:
forming a transparent insulating layer covering the protection layer; wherein the transparent insulating layer has a thickness which is larger than the first thickness; and
forming the spacer and the spacer material reservation portion on the protection layer by performing a single patterning process on the transparent insulating layer.

3. The method according to claim 2, wherein the transparent insulating layer is made of a photoresist material.

4. The method according to claim 3, wherein the forming the spacer and the spacer material reservation portion on the protection layer by performing a single patterning process on the transparent insulating layer comprises:
exposing and developing the transparent insulating layer with a mask plate, so as to form a completely-reserved portion, a partially-reserved portion and an completely-removed region; wherein the completely-reserved portion forms the spacer; the partially-reserved portion forms the spacer material reservation portion, and the partially-reserved portion has a thickness which is substantially equal to the first thickness; the completely-removed region corresponds to a region other than regions where the completely-reserved portion and the partially-reserved portion are located on the transparent insulating layer.

5. The method according to claim 4, wherein the mask plate is a gray-tone mask plate or a half-tone mask plate.

6. The method according to claim 4, wherein before exposing and developing the transparent insulating layer with the mask plate, the method further comprises:
determining a light shielding rate of a partially transparent region corresponding to the spacer material reservation portion in the mask plate according to the thickness of the spacer material reservation portion and the thickness of the transparent insulating layer.

7. The method according to claim 6, wherein
the transparent insulating layer is made of a positive photoresist; and
the light shielding rate of the partially transparent region is a ratio of the thickness of the spacer material reservation portion to the thickness of the transparent insulating layer.

8. The method according to claim 6, wherein
the transparent insulating layer is made of a negative photoresist; and
the light shielding rate of the partially transparent region is a ratio of a difference between the thickness of the transparent insulating layer and the thickness of the spacer material reservation portion to the thickness of the transparent insulating layer.

9. The method according to claim 4, wherein before forming the completely-reserved portion, the partially-reserved portion and the completely-removed region, the method further comprises:
determining an exposure intensity and an exposure time according to the thickness of the partially-reserved portion.

10. The method according to claim 1, wherein before forming the first color filter layer, the second color filter layer and the third color filter layer respectively located at the first subpixel region, the second subpixel region and the third subpixel region on the base substrate, further comprising:
forming a black matrix on the base substrate, wherein an open region of the black matrix defines the first subpixel region, the second subpixel region, the third subpixel region and the fourth subpixel region.

11. The method according to claim 1, wherein the spacer is located at the first subpixel region, the second subpixel region and the third subpixel region.

12. The method according to claim 1, wherein the first color filter layer is a red color filter layer, the second color filter layer is a green color filter layer and the third color filter layer is a blue color filter layer.

13. The method according to claim 1, wherein before forming the first color filter layer, the second color filter layer and the third color filter layer respectively located at the first subpixel region, the second subpixel region and the third subpixel region on the base substrate, further comprising:
forming a transparent electrostatic shielding layer at one side of the base substrate away from the protection layer.

14. A color filter substrate, being divided into a first subpixel region, a second subpixel region, a third subpixel region and a fourth subpixel region, comprising:
a first color filter layer, a second color filter layer and a third color filter layer respectively located at the first subpixel region, the second subpixel region and the third subpixel region on a base substrate;
a protection layer covering the base substrate; and
a spacer and a spacer material reservation portion arranged above the protection layer;
wherein the first color filter layer, the second color filter layer and the third color filter layer have a first thickness; and the spacer material reservation portion is located at the fourth subpixel region, and the spacer material reservation portion has a thickness which is substantially equal to the first thickness.

15. The color filter substrate according to claim 14, wherein the spacer and the spacer material reservation portion are made of a transparent insulating material.

16. The color filter substrate according to claim 15, wherein the transparent insulating material comprises a photoresist material.

17. The color filter substrate according to claim 14, wherein the spacer is located at the first subpixel region, the second subpixel region and the third subpixel region.

18. The color filter substrate according to claim 14, further comprising:
a black matrix arranged on the base substrate, wherein an open region of the black matrix defines the first subpixel region, the second subpixel region, the third subpixel region and the fourth subpixel region.

19. The color filter substrate according to claim 14, further comprising:
a transparent electrostatic shielding layer arranged at one side of the base substrate away from the protection layer.

20. A display device, comprising the color filter substrate according to claim 14.
